(19) United States
(12) Patent Application Publication
(10) Pub. No.: US 2025/0383512 A1
(43) Pub. Date: Dec. 18, 2025

(54) OPTICAL MODULE INCLUDING MOUNTING COMPONENT AND PULL TAB

(71) Applicant: Prime World International Holdings Ltd., New Taipei City (TW)

(72) Inventors: Che-Shou YEH, New Taipei City (TW); Ming-You LAI, New Taipei City (TW); Hsuan-Chen SHIU, New Taipei City (TW); Yu CHEN, New Taipei City (TW); YI-JU WANG, New Taipei City (TW); Ling-An KUNG, New Taipei City (TW)

(21) Appl. No.: 18/889,741

(22) Filed: Sep. 19, 2024

(30) Foreign Application Priority Data
Jun. 18, 2024 (TW) 113122442

(51) Int. Cl. G02B 6/38

(52) U.S. Cl. CPC G02B 6/3893; G02B 6/3821; G02B 6/3897

(57) ABSTRACT

The present disclosure provides an optical module, including a housing and a release mechanism. The housing comprises a side surface and an adjacent surface that are coupled to each other. The release mechanism includes an engagement component, a mounting component, and a pull tab. The engagement component is movably disposed on the housing, the engagement component includes an engagement arm and a linkage arm that are coupled to each other, the engagement arm is disposed on the side surface, and the linkage arm is disposed on the adjacent surface. The mounting component is engaged with the engagement component. The pull tab is disposed on the mounting component.

### CROSS-REFERENCE TO RELATED APPLICATIONS

This non-provisional application claims priority under 35 U.S.C. § 119 (a) on Patent Application No(s). 113122442 filed in Taiwan, ROC on Jun. 18, 2024, the entire contents of which are hereby incorporated by reference.

### BACKGROUND

### Technical Field

The present disclosure relates to an optical module.

### Related Art

Optical modules can transmit and/or receive optical signals for various applications including, but not limited to, internet data center, Cable TV, and fiber to the home (FTTH). Using optical modules for transmission can provide higher transmission rates and signal bandwidth over longer transmission distances. In order to enhance the compatibility of optical internetworking products all over the world and to reduce the burden of maintenance, organizations such as Multi-Source Agreement (MSA), Institute of Electrical and Electronic Engineers (IEEE), and Optical Internetworking Forum (OIF) have developed several form factors adapted to different signal transmission rates. These form factors include, but not limited to, XFP, SFP, QSFP (Quad Small Form Factor Pluggable), QSFP-DD (Double Density), OSFP (Octal Small Form Factor Pluggable), and CPO (Co-Packaged Optics).

However, conventional optical modules still present some problems, such as optical efficiency (power), space management, thermal management, insertion loss, and manufacturing yield.

### SUMMARY

According to one embodiment of the present disclosure, an optical module is configured to be inserted into a cage in a pluggable manner. The optical module includes a housing and a release mechanism. The housing has a side surface and an adjacent surface that are coupled to each other. The release mechanism includes an engagement component, a mounting component, and a pull tab. The engagement component is movably disposed on the housing and configured to be detachably engaged with the cage, the engagement component includes an engagement arm and a linkage arm that are coupled to each other, the engagement arm is disposed on the side surface, and the linkage arm is disposed on the adjacent surface. The mounting component is engaged with the engagement component. The pull tab is disposed on the mounting component.

According to another embodiment of the present disclosure, an optical module is configured to be inserted into a cage in a pluggable manner. The optical module includes a housing and a release mechanism. The release mechanism includes an engagement component, a mounting component, a pull tab, and a limiting component. The engagement component is movably disposed on the housing and configured to be detachably engaged with the cage. The mounting component is engaged with the engagement component. The pull tab is disposed on the mounting component. The mounting component is located between the engagement component and the limiting component, and the limiting component is disposed on at least one of the housing and the engagement component to limit movement of the mounting component.

### BRIEF DESCRIPTION OF THE DRAWINGS

The present disclosure will become better understood from the detailed description given hereinbelow and the accompanying drawings which are given by way of illustration only and thus are not intended to limit the present disclosure and wherein:

FIG. 1 is an exploded view of an optical module according to one embodiment of the present disclosure and a cage;

FIG. 2 is a partially enlarged cross-sectional view of the optical module in FIG. 1 showing that an engagement component is at an engagement position;

FIG. 3 is a partially enlarged cross-sectional view of the optical module in FIG. 1 showing that the engagement component is at a releasing position;

FIG. 4 is a perspective view of the optical module in FIG. 1;

FIG. 5 is an exploded view of the optical module in FIG. 4;

FIG. 6 is a partially enlarged view of the optical module in FIG. 4;

FIG. 7 is a side view of the optical module in FIG. 4; and

FIG. 8 is a perspective view of an optical module according to another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

In general, an optical module and a cage are firmly engaged with each other by a release mechanism disposed on the optical module. The engagement between the optical module and the cage may be released by the release mechanism when necessary, and then the optical module is allowed to be removed from the cage. A conventional release mechanism is provided with a user-friendly pull tab, and an engagement component of the pull tab for being engaged with the cage may be formed by injection molding. Since the pull tab is fixed with respect to the engagement component, the pull tab may disturb the installation or removal of an optical fiber or a jumper into or from an optical port of the optical module. Also, the exposed pull tab is frequently touched or subjected to collisions, and thus may easily be dirty or damaged. However, the pull tab is not allowed to be replaced by a new one without replacing the entire release mechanism, which makes the maintenance of the current release mechanism to be costly.

According to one embodiment, because the pull tab is disposed in a manner where the mounting component is engaged with the engagement component, the user may remove the pull tab by detaching the mounting component from the engagement component. The dirty or damaged pull tab can be replaced without replacing the engagement component, and thus the cost of the maintenance of the release mechanism is reduced and the maintenance of the release mechanism is simplified. In order to reduce the cost of maintenance, the pull tab may be made of plastic material. In order to ensure flexibility and prolong the lifespan, the engagement component may be made of metal material.

According to one embodiment, because the mounting component is engaged with the engagement component, it is necessary to prevent the mounting component from being detached from the engagement component accidentally during the operation of the release mechanism. Therefore, the release mechanism may further include a limiting component, which may limit the movement of the mounting component in the vertical direction.

Some or all of the technical features disclosed in one or more embodiments of the present disclosure may be combined to achieve corresponding effects.

The term “couple” or “coupled to” refers to any connection, link, or the like. Moreover, the term “optically couple” or “optically coupled to” refers to a relationship where light is transmitted (imparted) from a device to another. Unless otherwise specified, devices that “couple” or “coupled to” each other do not need to be directly connected to each other and may be separated by intervening objects.

The term substantially, as generally referred to herein, refers to a degree of precision within acceptable tolerance that accounts for and reflects minor real-world variation due to material composition, material defects, and/or limitations/peculiarities in manufacturing processes. Such variation may therefore be said to achieve largely, but not necessarily wholly, the stated characteristic.

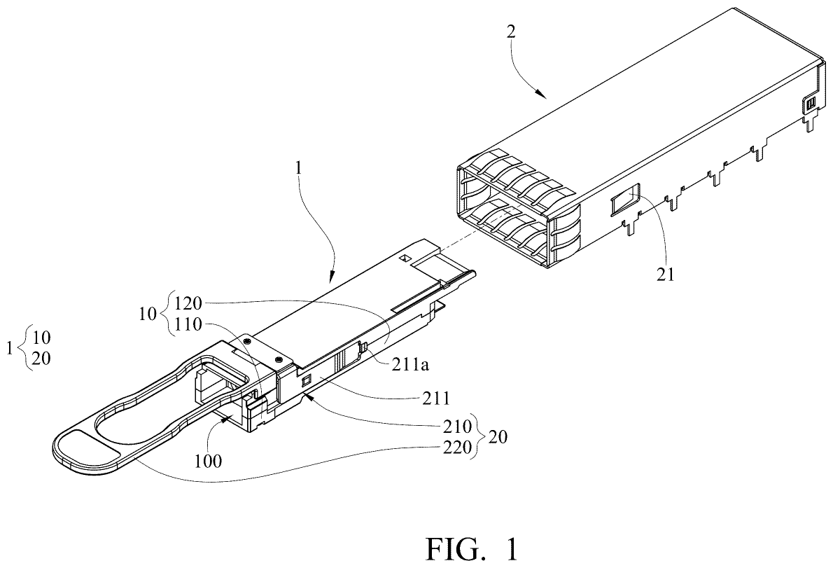

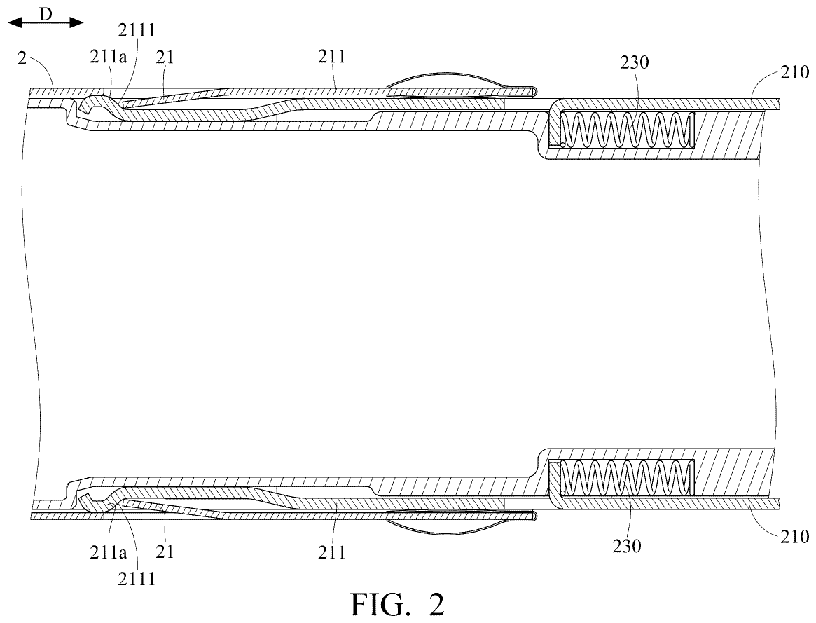

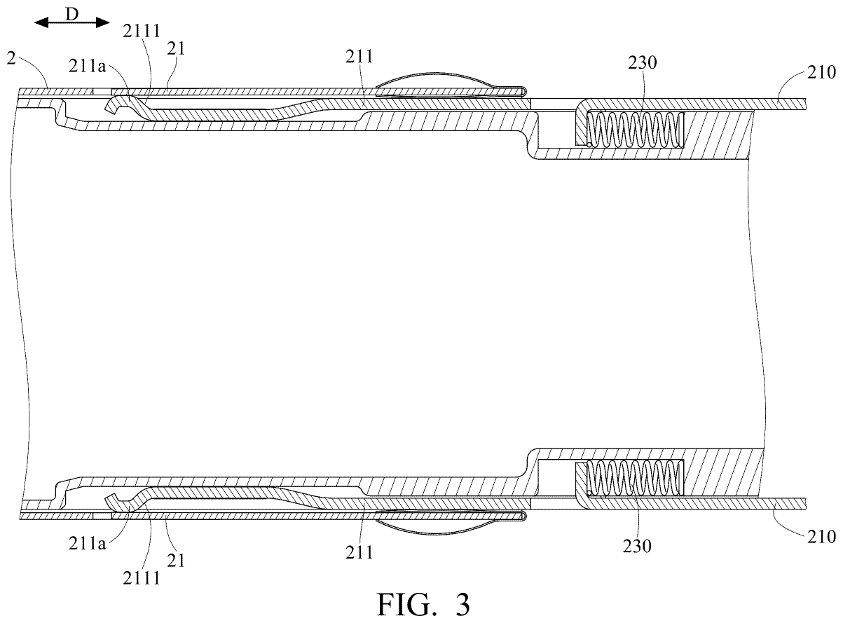

Please refer to FIGS. 1 to 3. FIG. 1 is an exploded view of an optical module 1 according to one embodiment of the present disclosure and a cage 2, FIG. 2 is a partially enlarged cross-sectional view of the optical module 1 in FIG. 1 showing that an engagement component 210 is at an engagement position, and FIG. 3 is a partially enlarged cross-sectional view of the optical module 1 in FIG. 1 showing that the engagement component 210 is at a releasing position. In this embodiment, the optical module 1 may be inserted into the cage 2 in a pluggable manner. The optical module 1 may be understood as an optical transceiver, and the cage 2 may be understood as a metal cage of a motherboard installed in an ether network device.

The optical module 1 may include a housing 10 and a release mechanism 20. The housing 10 may include a head portion 110 and an insertion portion 120 coupled to each other. The insertion portion 120 may be configured to be inserted into the cage 2. The head portion 110 may have an optical port 100. The optical port 100 may accommodate optical couplers such as an optical fiber connector or an active optical cable (AOC).

The housing 10 may be a housing made of metal. In one embodiment, the housing 10 may be understood as a hermetic housing or a non-hermetic housing configured to encapsulate one or more laser diodes. In one embodiment, the housing 10 may accommodate a printed circuit board assembly (PCBA) and one or more optical communication components disposed on the PCBA. For example, the optical communication components may include, but not limited to, at least one of a transmitting optical sub-assembly (TOSA) and a receiver optical sub-assembly (ROSA). In one embodiment, the housing 10 may be integrally formed as a single piece, or the housing 10 may include an upper housing part and a lower housing part that are assembled to each other.

The release mechanism 20 may include the engagement component 210 and a pull tab 220. In one embodiment, the engagement component 210 may include an engagement arm 211, and the engagement arm 211 may be movably disposed on an outer side surface of the housing 10. FIGS. 1 to 3 illustrate that the engagement component 210 may include two engagement arms 211 located on opposite sides of the housing 10, respectively. However, the specific configuration of the engagement component 210 is not limited thereto. In some embodiments, the engagement component 210 may include single engagement arm 211. The engagement arm 211 of the engagement component 210 may include an engagement portion 211a corresponding to a slot on the cage 2. The engagement component 210 may be moved relative to the housing 10 so as to interlock the engagement portion 211a with the slot on the cage 2. The pull tab 220 may be disposed on the engagement component 210. In one embodiment, the pull tab 220 may be fixed to the engagement component 210.

In one embodiment, the release mechanism 20 may further include elastic components 230 whose number is the same as that of the engagement arms 211. The elastic component 230 is disposed on the housing 10 and constantly presses against the engagement component 210.

The engagement component 210 may be moved between the engagement position (as shown in FIG. 2) and the releasing position (as shown in FIG. 3) relative to the housing 10 along a releasing direction D. In one embodiment, as shown in FIG. 2, the elastic component 230 may press against the engagement component 210 so as to keep the engagement component 210 at the engagement position, and thus the engagement portion 211a is stably engaged with the cage 2. Therefore, the optical module 1 can be firmly inserted into the cage 2.

As shown in FIGS. 1 to 3, a user may move the engagement component 210 relative to the housing 10 along the releasing direction D by pulling the pull tab 220. The engagement portion 211a may push a flexible arm 21 of the cage 2 so that the engagement portion 211a slides with the help of an inclined surface 2111 thereof. The engagement portion 211a may bend the flexible arm 21 so as to move the engagement component 210 to the releasing position. When the pull tab 220 is further pulled along the releasing direction D, the insertion portion 120 of the housing 10 may be removed from the cage 2.

Besides, when the engagement component 210 is at the releasing position, it may compress the elastic component 230. When the user releases the pull tab 220, the elastic potential energy stored in the elastic component 230 may be released to restore the engagement component 210 back to the engagement position.

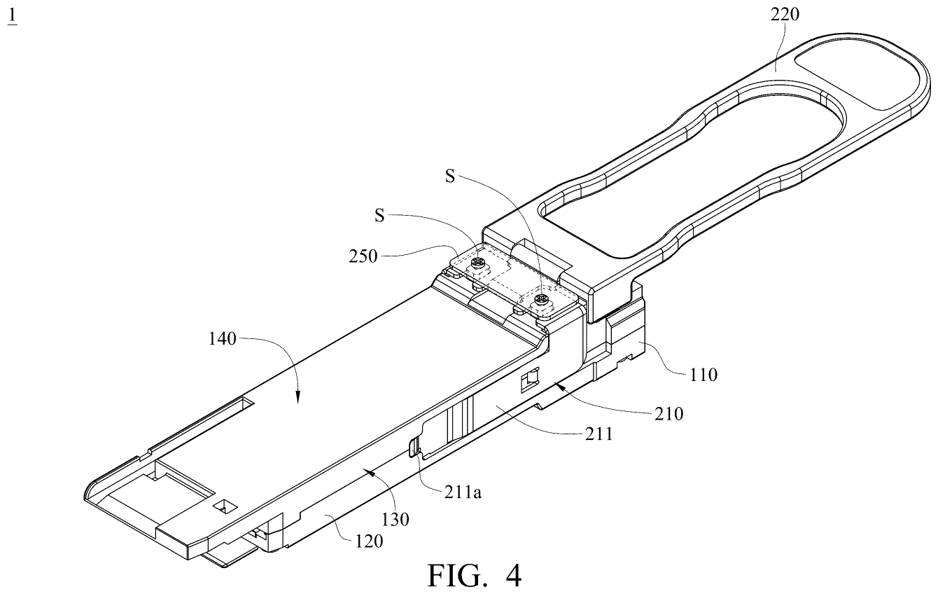

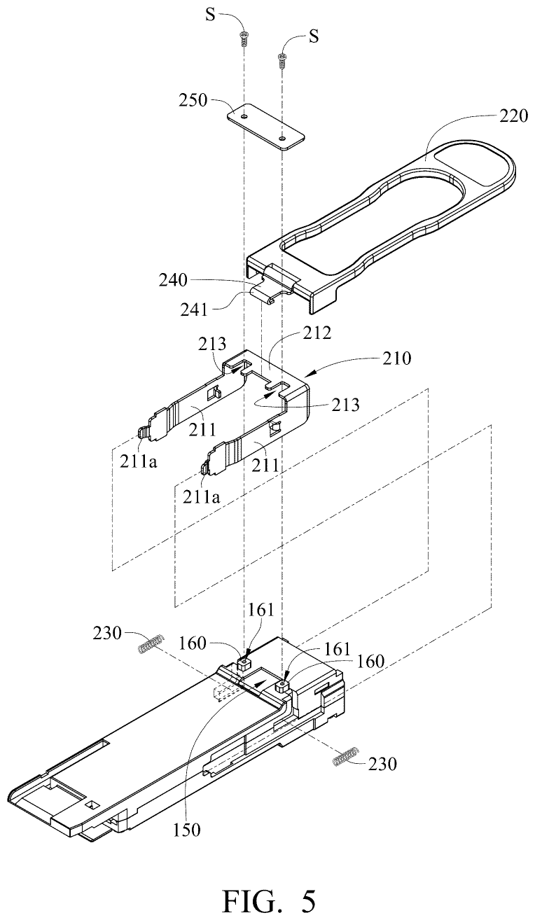

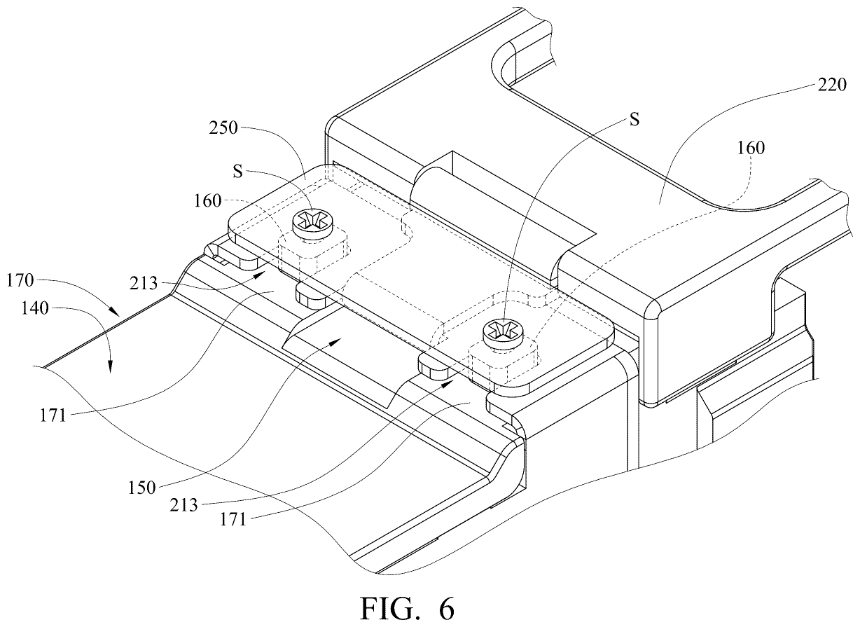

The pull tab 220 is disposed on the engagement component 210 in a detachable manner. Please refer to FIGS. 4 to 6. FIG. 4 is a perspective view of the optical module 1 in FIG. 1, FIG. 5 is an exploded view of the optical module 1 in FIG. 4, and FIG. 6 is a partially enlarged view of the optical module 1 in FIG. 4. In this embodiment, the housing 10 may have a side surface 130 and an adjacent surface 140 which are coupled to each other. The adjacent surface 140 may be a top surface or a bottom surface of the housing 10, where FIG. 4 exemplarily illustrates that the adjacent surface 140 is the top surface. Besides, FIG. 3 also exemplarily illustrates that the housing 10 includes multiple housing parts that are assembled to each other, and the housing parts together form the side surface 130.

The release mechanism 20 may further include a mounting component 240. In one embodiment, the engagement component 210 may include a linkage arm 212 that is coupled to the engagement arm 211. The linkage arm 212 may couple two engagement arms 211. The engagement arms 211 may be disposed on the side surface 130 of the housing 10, and the linkage arm 212 may be disposed on the adjacent surface 140 of the housing 10. The mounting component 240 may be engaged with the engagement component 210, and the pull tab 220 may be disposed on the mounting component 240. In one embodiment, the mounting component 240 may be a metal component that is made by stamping process or cutting process.

In one embodiment, a tight fit may be formed between the mounting component 240 and an engagement recess of the engagement component 210. In one embodiment, the mounting component 240 may have a hook portion 241 interlocked with the engagement component 210. In one embodiment, the hook portion 241 may be interlocked with linkage arm 212, and the pull tab 220 may be pivotally coupled to a side of the mounting component 240 away from the hook portion 241. However, the present disclosure is not limited thereto. In some embodiments, the hook portion 241 may be interlocked with any one of the engagement arms 211, or may be interlocked with both of the linkage arm 212 and the engagement arms 211. In some embodiments, the pull tab 220 may be fixed to the mounting component 240.

The mounting component 240 and the pull tab 220 may be made of different materials. In one embodiment, the mounting component 240 and the engagement component 210 may be made of the same material. In one embodiment, the mounting component 240 may be made of metal, and the pull tab 220 may be made of plastic. In one embodiment, the mounting component 240 and the engagement component 210 may be made of metal (i.e., mounting component 240 and the engagement component 210 may be two metal components that are spaced apart from each other).

The housing 10 may have a recess 150. In one embodiment, the adjacent surface 140 of the housing 10 may have the recess 150 corresponding to the hook portion 241 of the mounting component 240. The recess 150 may be located below the linkage arm 212 of the engagement component 210, and at least a part of the hook portion 241 may be located in the recess 150. In one embodiment, a part of the hook portion 241 may be bent to be allowed to extend into the recess 150. Therefore, a contact area between the hook portion 241 and the linkage arm 212 may be increased to obtain a sufficient hooking area for improving the hooking strength.

The release mechanism 20 may further include a limiting component 250. In one embodiment, the mounting component 240 may be located between the linkage arm 212 and the limiting component 250. In one embodiment, the limiting component 250 may be disposed on at least one of the housing 10 and the engagement component 210 to limit the movement of the mounting component 240. In one embodiment, the limiting component 250 may be fixed to the housing 10 to limit the movement of the mounting component 240 in a vertical direction. The vertical direction may be substantially perpendicular to the releasing direction D shown in FIGS. 2 and 3, or may be substantially perpendicular to a longitudinal direction of the housing 10 that is substantially parallel to the releasing direction D. FIG. 4 exemplarily illustrates that a metal plate which is the limiting component 250 is screwed to the adjacent surface 140 of the housing 10, but the present disclosure is not limited thereto. In other embodiments, the limiting component 250 may be detachably engaged with the adjacent surface 140 of the housing 10. In other embodiments, the limiting component 250 may be fixed to the linkage arm 212 of the engagement component 210.

The limiting component 250 and the housing 10 may be separate components. In one embodiment, the limiting component 250 and the housing 10 may be independent (i.e., they are not integrally formed as a single piece).

The housing 10 may include at least one mounting protrusion 160. In one embodiment, the housing 10 may include a main body 170 and a mounting protrusion 160. The main body 170 may have the aforementioned side surface 130 and the adjacent surface 140, and the mounting protrusion 160 may be located on the adjacent surface 140. The limiting component 250 may be fixed to the mounting protrusion 160. FIG. 5 exemplarily illustrates that the housing 10 includes two mounting protrusions 160, the recess 150 is located between the two mounting protrusions 160, and each of the mounting protrusion 160 has a threaded hole 161 matched with a screw S to allow the limiting component 250 to be screwed therein. However, the number, the position, and the specific aspect of the mounting protrusion 160 are not limited thereto.

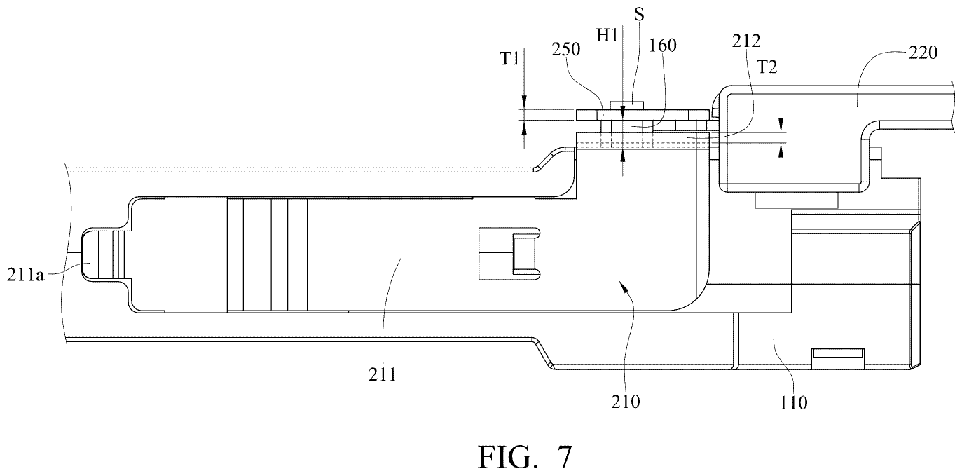

A thickness T1 of the limiting component 250 may be smaller than or equal to a thickness of the engagement component 210. Please refer to FIG. 7. FIG. 7 is a side view of the optical module 1 in FIG. 4. The thickness T1 of the limiting component 250 may be smaller than or equal to the thickness T2 of the linkage arm 212. In one embodiment, the thickness T1 of the limiting component 250 may be smaller than the thickness T2 of the linkage arm 212. Therefore, both of the configuration of the limiting component 250 and the specification of the optical module 1 may be satisfied. Besides, a height H1 of the mounting protrusion 160 may be larger than the thickness of the engagement component 210. As shown in FIG. 7, the height H1 of the mounting protrusion 160 may be larger than the thickness T2 of the linkage arm 212. Therefore, a gap may be formed between the limiting component 250 and the linkage arm 212 to accommodate a part of the mounting component 240.

The engagement component 210 may have at least one notch 213. In one embodiment, the engagement component 210 may have the notch 213 corresponding to the mounting protrusion 160. The number of the notch 213 may be equal to the number of the mounting protrusion 160, and the notch 213 may extend from an edge of the linkage arm 212. The notch 213 is allowed to accommodate the mounting protrusion 160, and the mounting protrusion 160 may extend beyond a top surface of the linkage arm 212 by passing through the notch 213. FIGS. 5 and 6 exemplarily illustrate that the linkage arm 212 of the engagement component 210 has two notches 213.

The main body 170 may have a protrusion 171. In one embodiment, the adjacent surface 140 of the main body 170 may have two protrusions 171, and the recess 150 may be located between the two protrusions 171. The mounting protrusion 160 may be located on the protrusion 171. Therefore, the mounting protrusion 160 may protrude from the top surface of the linkage arm 212 in a case where a shorter mounting protrusion 160 is formed, thereby facilitating the process for forming the mounting protrusion 160.

Because the pull tab 220 is disposed in a manner where the mounting component 240 is engaged with the engagement component 210, the user may remove the pull tab 220 by detaching the mounting component 240 from the engagement component 210. The dirty or damaged pull tab 220 can be replaced without replacing the engagement component 210, and thus the cost of the maintenance of the release mechanism 20 is reduced and the maintenance of the release mechanism 20 is simplified. In order to reduce the cost of maintenance, the pull tab 220 may be made of plastic material. In order to ensure flexibility and prolong the lifespan, the engagement component 210 may be made of metal material.

Besides, because the mounting component 240 is engaged with the engagement component 210, it is necessary to prevent the mounting component 240 from being detached from the engagement component 210 accidentally during the operation of the release mechanism 20. Therefore, the release mechanism 20 may further include the limiting component 250, which may limit the movement of the mounting component 240 in the vertical direction.

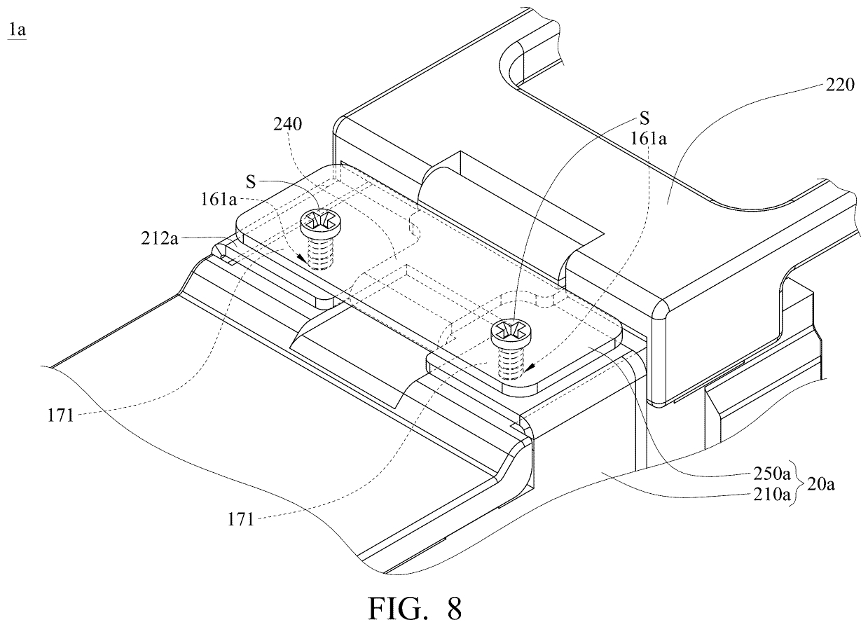

FIG. 4 exemplarily illustrates that the limiting component 250 is fixed to the housing 10, but the present disclosure is not limited thereto. FIG. 8 is a perspective view of an optical module 1a according to another embodiment of the present disclosure. In this embodiment, the optical module 1a may include a release mechanism 20a, and the release mechanism 20a may include an engagement component 210a and a limiting component 250a. Because the specific descriptions related to the engagement component 210a may correspond to the aforesaid description made by referring to FIGS. 1 to 7, they will be omitted hereinafter.

In this embodiment, the limiting component 250a may be fixed to the engagement component 210a. In one embodiment, the limiting component 250a may be fixed to the linkage arm 212a of the engagement component 210a, and the protrusion 171 may have a threaded hole 161a matched with the screw S to allow the limiting component 250a to be screwed therein. The mounting component 240 may pass through a gap located between the limiting component 250a and the linkage arm 212a.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An optical module, comprising:
a housing, having a side surface and an adjacent surface that are coupled to each other; and
a release mechanism, comprising:
an engagement component, movably disposed on the housing, wherein the engagement component comprises an engagement arm and a linkage arm that are coupled to each other, the engagement arm is disposed on the side surface, and the linkage arm is disposed on the adjacent surface;
a mounting component, engaged with the engagement component; and
a pull tab, disposed on the mounting component.

2. The optical module according to claim 1, wherein the adjacent surface of the housing comprises a recess, the mounting component comprises a hook portion interlocked with the linkage arm, and at least a part of the hook portion is disposed in the recess.

3. The optical module according to claim 1, wherein the release mechanism further comprises a limiting component, wherein the mounting component is disposed between the linkage arm and the limiting component, and the limiting component is disposed on at least one of the housing and the engagement component to limit a movement of the mounting component.

4. The optical module according to claim 3, wherein the limiting component is fixed to the adjacent surface of the housing.

5. The optical module according to claim 4, wherein the limiting component and the housing are separate components.

6. The optical module according to claim 4, wherein the housing comprises a main body and a mounting protrusion, the main body comprises the side surface and the adjacent surface, the mounting protrusion is disposed on the adjacent surface, and the limiting component is fixed to the mounting protrusion.

7. The optical module according to claim 6, wherein the linkage arm of the engagement component comprises a notch corresponding to the mounting protrusion, a height of the mounting protrusion is larger than a thickness of the linkage arm, and the notch is allowed to accommodate the mounting protrusion.

8. The optical module according to claim 6, wherein the adjacent surface comprises two protrusions and a recess disposed between the two protrusions, the mounting protrusion is disposed on the protrusion, the mounting component comprises a hook portion interlocked with the linkage arm, and at least a part of the hook portion is disposed in the recess.

9. The optical module according to claim 3, wherein a thickness of the limiting component is smaller than or equal to a thickness of the linkage arm.

10. An optical module, comprising:
a housing; and
a release mechanism, comprising:
an engagement component, movably disposed on the housing;
a mounting component, engaged with the engagement component;
a pull tab, disposed on the mounting component; and
a limiting component, wherein the mounting component is disposed between the engagement component and the limiting component, and the limiting component is disposed on at least one of the housing and the engagement component to limit a movement of the mounting component.

11. The optical module according to claim 10, wherein the limiting component and the housing are separate components.

12. The optical module according to claim 10, wherein the housing comprises a recess, the mounting component comprises a hook portion interlocked with the engagement component, and at least a part of the hook portion is disposed in the recess.

13. The optical module according to claim 10, wherein the housing comprises a main body and a mounting protrusion, and the limiting component is fixed to the mounting protrusion.

14. The optical module according to claim 13, wherein the engagement component comprises a notch corresponding to the mounting protrusion, a height of the mounting protrusion is larger than a thickness of the engagement component, and the notch is allowed to accommodate the mounting protrusion.

15. The optical module according to claim 13, wherein the main body comprises two protrusions and a recess disposed between the two protrusions, the mounting protrusion is disposed on the protrusion, the mounting component comprises a hook portion interlocked with the engagement component, and at least a part of the hook portion is disposed in the recess.

16. The optical module according to claim 10, wherein a thickness of the limiting component is smaller than or equal to a thickness the engagement component.
